(19) United States
(12) Patent Application Publication
(10) Pub. No.: US 2025/0002415 A1
(43) Pub. Date: Jan. 2, 2025

(54) TAPE GREEN BODY INCLUDING INORGANIC HYDROXIDE TO REDUCE IGNITION DURING BINDER BURNOUT AND METHOD OF MANUFACTURING CERAMIC TAPE FROM THE TAPE GREEN BODY

(71) Applicant: CORNING INCORPORATED, CORNING, NY (US)

(72) Inventors: Dane Alphanso Christie, Painted Post, NY (US); Cameron Wayne Tanner, Horseheads, NY (US)

(21) Appl. No.: 18/753,008

(22) Filed: Jun. 25, 2024

Related U.S. Application Data
(60) Provisional application No. 63/523,431, filed on Jun. 27, 2023.

(51) Int. Cl. C04B 35/01; C04B 35/63; C04B 35/634; C04B 35/638; C04B 35/64

(52) U.S. Cl. CPC C04B 35/01; C04B 35/6303; C04B 35/6342; C04B 35/638; C04B 35/64; C04B 2235/3206; C04B 2235/3275; C04B 2235/442; C04B 2235/6025; C04B 2235/656; C04B 2235/661

(57) ABSTRACT

A tape green body including (i) inorganic sinterable material; (ii) an inorganic hydroxide; and (iii) a binder. The inorganic sinterable material can include a lithium-containing ceramic material. The inorganic hydroxide can be less than or equal 20 wt % of the tape green body. The inorganic hydroxide exhibits an endothermic decomposition. The tape green body exhibits a lack of ignition during a continuous process of transforming the tape green body into a ceramic tape at a conveyance rate of greater than or equal to 70 mm/min, or even greater than or equal to 100 mm/min. A method of manufacturing the ceramic tape from the tape green body includes a continuous binder burnout step that includes feeding the tape green body through a burnout heating zone having a burnout temperature sufficient to burn out at least a portion of the binder from the tape green body without igniting the tape green body.

### CROSS-REFERENCE TO RELATED APPLICATIONS

This application claims the benefit of priority under 35 U.S.C. § 119 of U.S. Provisional Application Ser. No. 63/523,431 filed on Jun. 27, 2023, the content of which is relied upon and incorporated herein by reference in its entirety.

### TECHNICAL FIELD OF THE DISCLOSURE

This disclosure pertains to tape green bodies used to make ceramic tape and, more particularly, to tape green bodies that include a binder and an inorganic hydroxide to reduce ignition of the tape green bodies during binder burnout.

### BACKGROUND

Ceramic tapes have been utilized in a variety of industries to provide a variety of benefits. For example, the aerospace industry utilizes ceramic tapes to provide thermal insulation for aircraft and spacecraft. As another example, the electronic industry utilizes ceramic tapes for electrical insulation, such as a dielectric material incorporated into multi-layer ceramic capacitors.

Such ceramic tapes can be made by first forming a tape green body that includes a binder that holds together precursor ceramic materials. The tape green body is then subjected to a heat treatment to remove the binder. The tape green body is then sintered. The sintering burns out any remaining binder and transforms the tape green body into a ceramic tape.

### SUMMARY

This disclosure relates to efforts to manufacture the ceramic tape in a continuous process, rather than a batch process. In the continuous process, the tape green body is fed as a continuous stream into a first furnace that removes (e.g., burns out) binder from the tape green body to form a debound body. The debound body, still attached as a single piece to tape green body of new being fed into the first furnace, is then directed into a second furnace that sinters the debound body into the ceramic tape. The ceramic tape is then collected via a winding mechanism, among other options. There is a general desire to quicken the continuous process of transforming the tape green body into the ceramic tape.

However, there is a problem in that the decomposition of the binder that occurs during burnout of the binder from the tape green body is exothermic. Faster removal of the binder results in the tape green body experiencing higher temperatures. The higher temperatures can cause the tape green body to ignite. The faster the process, the more likely the burnout of the binder in the first furnace is to cause ignition of the tape green body. Ignition of the tape green body results in manufacturing failure, because the tape green body fractures and cracks along a front where ignition occurs. The problem is especially prevalent in tape green bodies that include lithium manganese oxide (LiMn₂O₄) or lithium cobalt oxide (LiCoO₂).

The present disclosure addresses that problem by incorporating an inorganic hydroxide into the tape green body. Decomposition of the inorganic hydroxide is endothermic. Thus, as the binder is burnt out and releases heat, the inorganic hydroxide simultaneously decomposes as well but removes heat. The inorganic hydroxide removal of heat from the tape green body reduces the ability of the tape green body to ignite. The reduced ability of the tape green body to ignite allows the tape green body to be conveyed through the furnace where binder burnout occurs at a faster rate, thus allowing the continuous manufacturing process to be quickened.

According to a first aspect of the present disclosure, a tape green body comprises: (i) grains of inorganic sinterable material; (ii) from greater than 0 wt % to 7 wt % of an inorganic hydroxide; and (iii) a binder.

According to a second aspect of the present disclosure, the tape green body of the first aspect is presented, wherein the inorganic sinterable material is greater than or equal to 75 wt % of the tape green body.

According to a third aspect of the present disclosure, the tape green body of any one of the first through second aspects is presented, wherein the inorganic hydroxide is from greater than 0 wt % to 5 wt % of the tape green body.

According to a fourth aspect of the present disclosure, the tape green body of any one of the first through third aspects is presented, wherein the inorganic sinterable material comprises one or more of a ceramic material, a glass-ceramic material, or a metal.

According to a fifth aspect of the present disclosure, the tape green body of the fourth aspect is presented, wherein the ceramic material comprises one or more of an oxide, a carbide, a nitride, a boride, an oxynitride, a titanate, a phosphate, a silicate, a sulfide, a fluoride, a carbonate, a zirconate, and a cobaltite.

According to a sixth aspect of the present disclosure, the tape green body of the fourth aspect is presented, wherein the ceramic material comprises an alkali-containing ceramic material.

According to a seventh aspect of the present disclosure, the tape green body of the sixth aspect is presented, wherein the alkali-containing ceramic material is a lithium-containing ceramic material or a sodium-containing ceramic material.

According to an eighth aspect of the present disclosure, the tape green body of the seventh aspect is presented, wherein the lithium-containing ceramic material is one or more of lithium aluminum silicate (LiAlSiO₄); lithium aluminate (LiAlO₂); lithium titanate (Li₄Ti₅O₁₂); lithium niobate (LiNbO₃); lithium iron phosphate (LiFePO₄); lithium manganese oxide (LiMn₂O₄); lithium cobalt oxide (LiCoO₂); lithium nickel oxide (LiNiO₂); LiNiₓMn_{y}Co_{z}AlᵥO₂ where x+y+z+v=1, 0≤x≤1, 0≤y≤1, 0≤z≤1, 0≤v≤1; lithium vanadium oxide (LiV₃O₈); lithium tungsten oxide (Li₂WO₄); lithium lanthanum titanate (LiLaTiO₃); lithium strontium niobate (LiSrNbO₃); lithium sodium potassium niobate; lithium calcium silicate (Li₂CaSiO₄); lithium magnesium silicate (Li₂MgSiO₄); lithium zirconate (Li₂ZrO₃); lithium germanate (Li₂GeO₃); lithium borate (Li₂B₄O₇); lithium oxide (Li₂O); lithium lanthanum zirconium oxide (LLZO); lithium magnetite (LiFe₅O₈); lithium aluminum titanium phosphate (LATP); and lithium aluminum germanium phosphate (LAGP).

According to a ninth aspect of the present disclosure, the tape green body of any one of the first through eighth aspects is presented, wherein the inorganic hydroxide exhibits an endothermic decomposition.

According to a tenth aspect of the present disclosure, the tape green body of any one of the first through ninth aspects is presented, wherein the inorganic hydroxide comprises one or more of magnesium hydroxide (Mg(OH)₂), calcium hydroxide (Ca(OH)₂), barium hydroxide (Ba(OH)₂), strontium hydroxide (Sr(OH)₂)), aluminum hydroxide (Al(OH)₃), iron(III) hydroxide (Fe(OH)₃), bismuth hydroxide (Bi(OH)₃), nickel hydroxide (Ni(OH)₂), cobalt hydroxide (Co(OH)₂), aluminum oxide hydroxide (AlO(OH)), manganese hydroxide (Mn(OH)₂), zinc hydroxide (Zn(OH)₂), lanthanum hydroxide (La(OH)₃), copper(II) hydroxide (Cu(OH)₂), cadmium hydroxide (Cd(OH)₂), lead(II) hydroxide (Pb(OH)₂), chromium(III) hydroxide (Cr(OH)₃), iron(II) hydroxide (Fe(OH)₂), and thallium(I) hydroxide (TlOH).

According to an eleventh aspect of the present disclosure, the tape green body of any one of the first through tenth aspects is presented, wherein the tape green body exhibits a peak heat release during differential scanning calorimetry that is less than a peak heat release that the tape green body would exhibit without the inorganic hydroxide.

According to a twelfth aspect of the present disclosure, the tape green body of any one of the first through eleventh aspects is presented, wherein the peak heat release that tape green body exhibits is less than or equal to 2 W/g in the presence of an environment of 80% N₂ and 20% O₂.

According to a thirteenth aspect of the present disclosure, the tape green body of any one of the first through twelfth aspects is presented, wherein the binder comprises one or more of polyvinyl alcohol (PVA), polyethylene glycol (PEG), hydroxypropyl methylcellulose (HPMC), carboxymethylcellulose (CMC), polyacrylic acid (PAA), polyvinylpyrrolidone (PVP), polymethylmethacrylate (PMMA), polyethylmethacrylate (PEMA), polybutylmethacrylate (PBMA) polyhexylmethacrylate (PHMA), polymethylacrylate (PMA), polyethylacrylate (PEA), polybutylacrylate (PBA) polyhexylacrylate (PHMA), ethyl cellulose, cellulose acetate butyrate (CAB), methyl cellulose, polypropylene carbonate (PPC), polybutylene carbonate (PBC), polypropylene-co-cyclohexene carbonate (PPCC), polyvinyl butyral (PVB), a copolymer containing polystyrene, a co-polymer containing polyisobutylene, and a copolymer containing alkyl (meth)acrylates.

According to a fourteenth aspect of the present disclosure, the tape green body of the thirteenth aspect is presented, wherein the binder comprises one or more of poly(propylene carbonate) (PPC) and polyvinyl butyral (PVB).

According to a fifteenth aspect of the present disclosure, the tape green body of any one of the first through fourteenth aspects is presented, wherein (i) the inorganic hydroxide decomposes over at least a decomposition temperature range of from a decomposition onset temperature to a peak decomposition temperature; and (ii) the tape green body without the inorganic hydroxide exhibits a peak heat release at a temperature that is within the decomposition temperature range.

According to a sixteenth aspect of the present disclosure, the tape green body of any one of the first through fifteenth aspects further comprises a plasticizer.

According to a seventeenth aspect of the present disclosure, the tape green body of the sixteenth aspect is presented, wherein the plasticizer comprises one or more of dibutyl phthalate (DBP), butyl benzyl phthalate (BBP), triethyl citrate (TEC), acetyl tributyl citrate (ATBC), polyethylene glycol (PEG), trioctyl trimellitate (TOTM), polypropylene glycol (PPG), dioctyl terephthalate (DOTP), diisononyl cyclohexane-1,2-dicarboxylate (DINCH), and liquid paraffin.

According to an eighteenth aspect of the present disclosure, the tape green body of the sixteenth aspect is presented, wherein the plasticizer comprises dibutyl phthalate.

According to a nineteenth aspect of the present disclosure, the tape green body of any one of the first through eighteenth aspects further comprises a dispersant.

According to a twentieth aspect of the present disclosure, the tape green body of any one of the first through nineteenth aspects further comprises an additive, wherein, the additive is a sintering aid.

According to a twenty-first aspect of the present disclosure, the tape green body of the twentieth aspect is presented, wherein the sintering aid comprises one or more of cerium oxide, manganese dioxide (MnO₂), and lithium carbonate (Li₂CO₃).

According to a twenty-second aspect of the present disclosure, the tape green body of any one of the first through twenty-first aspects further comprises a width that is within a range of from 0.5 mm to 600 mm.

According to a twenty-third aspect of the present disclosure, the tape green body of any one of the first through twenty-second aspects further comprises a length that is greater than or equal to 300 cm.

According to a twenty-fourth aspect of the present disclosure, the tape green body of the twenty-third aspect is presented, wherein the length of the tape green body is within a range of from 300 cm to 5 km.

According to a twenty-fifth aspect of the present disclosure, the tape green body of any one of the first through twenty-fourth aspects further comprises a thickness within a range of from 10 μm to 250 μm.

According to a twenty-sixth aspect of the present disclosure, the tape green body of any one of the first through twenty-fifth aspects is presented, wherein the tape green body exhibits a lack of ignition during a continuous process of transforming the tape green body into a ceramic tape at a conveyance rate of greater than or equal to 70 mm/min.

According to a twenty-seventh aspect of the present disclosure, the tape green body of any one of the first through twenty-fifth aspects is presented, wherein the tape green body exhibits a lack of ignition during a continuous process of transforming the tape green body into a ceramic tape at a conveyance rate of greater than or equal to 100 mm/min.

According to a twenty-eighth aspect of the present disclosure, a method of manufacturing a ceramic tape comprises: with a tape green body comprising (i) grains of inorganic sinterable material, (ii) an inorganic hydroxide, and (iii) a binder, a continuous binder burnout step comprising feeding the tape green body through a burnout heating zone having a burnout temperature sufficient to burn out at least a portion of the binder from the tape green body.

According to a twenty-ninth aspect of the present disclosure, the method of the twenty-eighth aspect is presented, wherein the burnout temperature is within a range of from 150° C. to 600° C.

According to a thirtieth aspect of the present disclosure, the method of any one of the twenty-eighth through twenty-ninth aspects is presented, wherein the tape green body is fed through the burnout heating zone at a conveyance rate that is greater than or equal to 70 mm/min without the tape green body igniting.

According to a thirty-first aspect of the present disclosure, the method of any one of the twenty-eighth through twenty-ninth aspects is presented, wherein the tape green body is fed through the burnout heating zone at a conveyance rate that is greater than or equal to 100 mm/min without the tape green body igniting.

According to a thirty-second aspect of the present disclosure, the method of any one of the twenty-eighth through thirty-first aspects further comprises: a continuous feed step, occurring before the continuous binder burnout step, comprising feeding the tape green body from a source of the tape green body to the burnout heating zone.

According to a thirty-third aspect of the present disclosure, the method of the thirty-second aspect is presented, wherein (i) the source of the tape green body is a spool of the tape green body, and (ii) feeding the tape green body comprises unwinding the tape green body from the spool.

According to a thirty-fourth aspect of the present disclosure, the method of any one of the twenty-eighth through thirty-third aspects further comprises: a composition determination step, occurring before the continuous binder burnout step, comprising selecting the inorganic hydroxide and the binder of the tape green body as a function of the decomposition temperature range of the inorganic hydroxide and the temperature at which the tape green body exhibits peak heat release with the binder but in the absence of the inorganic hydroxide, wherein, the temperature at which the tape green body exhibits peak heat release with the binder but in the absence of the inorganic hydroxide falls within the decomposition temperature range of the inorganic hydroxide.

According to a thirty-fifth aspect of the present disclosure, the method of any one of the twenty-eighth through thirty-fourth aspects further comprises: a continuous sintering step, occurring after the continuous binder burnout step forms a debound tape from the tape green body, comprising feeding the debound tape through a sintering heating zone having a sintering temperature sufficient to sinter at least partially the bound tape into a ceramic tape.

According to a thirty-sixth aspect of the present disclosure, the method of the thirty-fifth aspect is presented, wherein the sintering temperature is within a range of from 500° C. to 1700° C.

According to a thirty-seventh aspect of the present disclosure, the method of any one of the thirty-fifth through thirty-sixth aspects is presented, wherein the debound tape is fed through the sintering heating zone at a conveyance rate that is greater than or equal to 70 mm/minute (˜2.76 inches/minute) without the debound tape igniting.

According to a thirty-eighth aspect of the present disclosure, the method of any one of the thirty-fifth through thirty-sixth aspects is presented, wherein the debound tape is fed through the sintering heating zone at a conveyance rate that is greater than or equal to 100 mm/minute without the debound tape igniting.

According to a thirty-ninth aspect of the present disclosure, the method of any one of the twenty-eighth through thirty-eighth aspects further comprises a continuous uptake step, occurring after the continuous sintering step, comprising winding the ceramic tape upon a reel.

According to a fortieth aspect of the present disclosure, the method of any one of the twenty-eighth through thirty-ninth aspects is presented, wherein (i) the inorganic sinterable material is greater than or equal to 75 wt % of the tape green body; and (ii) the inorganic hydroxide is less than or equal 20 wt % of the tape green body.

According to a forty-first aspect of the present disclosure, the method of any one of the twenty-eighth through fortieth aspects is presented, wherein the inorganic sinterable material comprises one or more of a ceramic material, a glass-ceramic material, and a metal.

According to a forty-second aspect of the present disclosure, the method of the forty-first aspect is presented, wherein the ceramic material of the tape green body comprises one or more of an oxide, a carbide, a nitride, a boride, an oxynitride, a titanate, a phosphate, a silicate, a sulfide, a fluoride, a carbonate, a zirconate, and a cobaltite.

According to a forty-third aspect of the present disclosure, the method of the forty-first aspect is presented, wherein the ceramic material of the tape green body comprises an alkali-containing ceramic material.

According to a forty-fourth aspect of the present disclosure, the method of any one of the twenty-eighth through forty-third aspects is presented, wherein the inorganic hydroxide of the tape green body exhibits an endothermic decomposition.

According to a forty-fifth aspect of the present disclosure, the method of any one of the twenty-eighth through forty-fourth aspects is presented, magnesium hydroxide (Mg(OH)₂), calcium hydroxide (Ca(OH)₂), barium hydroxide (Ba(OH)₂), strontium hydroxide (Sr(OH)₂)), aluminum hydroxide (Al(OH)₃), iron(III) hydroxide (Fe(OH)₃), bismuth hydroxide (Bi(OH)₃), nickel hydroxide (Ni(OH)₂), cobalt hydroxide (Co(OH)₂), aluminum oxide hydroxide (AlO(OH)), manganese hydroxide (Mn(OH)₂), zinc hydroxide (Zn(OH)₂), lanthanum hydroxide (La(OH)₃), copper(II) hydroxide (Cu(OH)₂), cadmium hydroxide (Cd(OH)₂), lead(II) hydroxide (Pb(OH)₂), chromium(III) hydroxide (Cr(OH)₃), iron(II) hydroxide (Fe(OH)₂), and thallium(I) hydroxide (TlOH).

According to a forty-sixth aspect of the present disclosure, the method of any one of the twenty-eighth through forty-fifth aspects is presented, wherein the binder of the tape green body comprises one or more of polyvinyl alcohol (PVA), polyethylene glycol (PEG), hydroxypropyl methylcellulose (HPMC), carboxymethylcellulose (CMC), polyacrylic acid (PAA), polyvinylpyrrolidone (PVP), polymethylmethacrylate (PMMA), polyethylmethacrylate (PEMA), polybutylmethacrylate (PBMA) polyhexylmethacrylate (PHMA), polymethylacrylate (PMA), polyethylacrylate (PEA), polybutylacrylate (PBA) polyhexylacrylate (PHMA), ethyl cellulose, cellulose acetate butyrate (CAB), methyl cellulose, polypropylene carbonate (PPC), polybutylene carbonate (PBC), polypropylene-co-cyclohexene carbonate (PPCC), polyvinyl butyral (PVB), a copolymer containing polystyrene, a co-polymer containing polyisobutylene, and a copolymer containing alkyl (meth)acrylates.

According to a forty-seventh aspect of the present disclosure, the method of any one of the twenty-eighth through forty-sixth aspects is presented, wherein the tape green body comprises (i) a width that is within a range of from 0.5 mm to 600 mm, (ii) a length that is greater than or equal to 300 cm, and (iii) a thickness that is within a range of from 10 μm to 250 μm.

### BRIEF DESCRIPTION OF THE DRAWINGS

In the Drawings:

FIG. 1 is a perspective view of a tape green body of the present disclosure, illustrating the tape green body including inorganic sinterable material, an inorganic hydroxide, and a binder;

FIG. 2 is a flow-chart of a method of manufacturing ceramic tape from the tape green body of FIG. 1, illustrating steps of a continuous binder burnout step, a continuous sintering step, and a continuous uptake step;

FIG. 3 is a perspective view of a system to perform the method of FIG. 2, illustrating the tape green body of FIG. 1 being directed from a source of the tape green body (such as a reel upon which the tape green body is wound), through a binder burnout zone to burn out the binder from the tape green body and form a debound tape, and through a sintering zone to sinter the debound tape into ceramic tape, which is then collected upon a reel;

FIG. 4 is a closer elevation view of a binder removal station providing the binder burnout zone and a sintering station providing the sintering zone;

FIG. 5 is a graph reproducing differential scanning calorimetry (DSC) curves of green tape bodies of Example 2 (including an inorganic hydroxide), Comparative Example 3 (not including an inorganic hydroxide), and Comparative Example 4 (also not including an inorganic hydroxide), illustrating Example 2 exhibiting a lower peak heat release than Comparative Examples 3 and 4;

FIG. 6A is a thermogravimetric curve for various materials; and

FIG. 6B is a DSC curve for various materials including an Example 3B of polypropylene carbonate (PPC) with lithium cobalt oxide (LiCoO₂) and an Example 3E of PPC with magnesium dioxide (MnO₂), illustrating that Example 3B exhibited an exothermic decomposition while Example 3E exhibited an endothermic decomposition that, if combined with Example 3B in a tape green body, could reduce the likelihood of the tape green body igniting during burnout of the PPC binder and allow for faster conveyance rates through the binder burnout zone.

### DETAILED DESCRIPTION

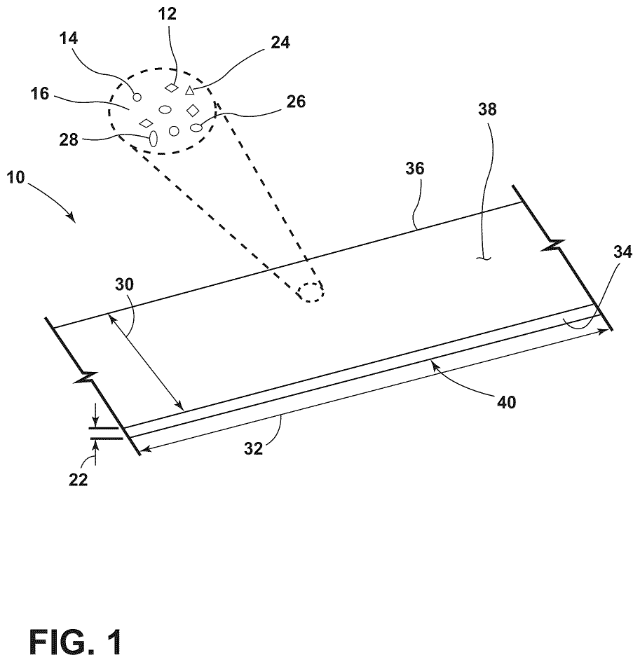

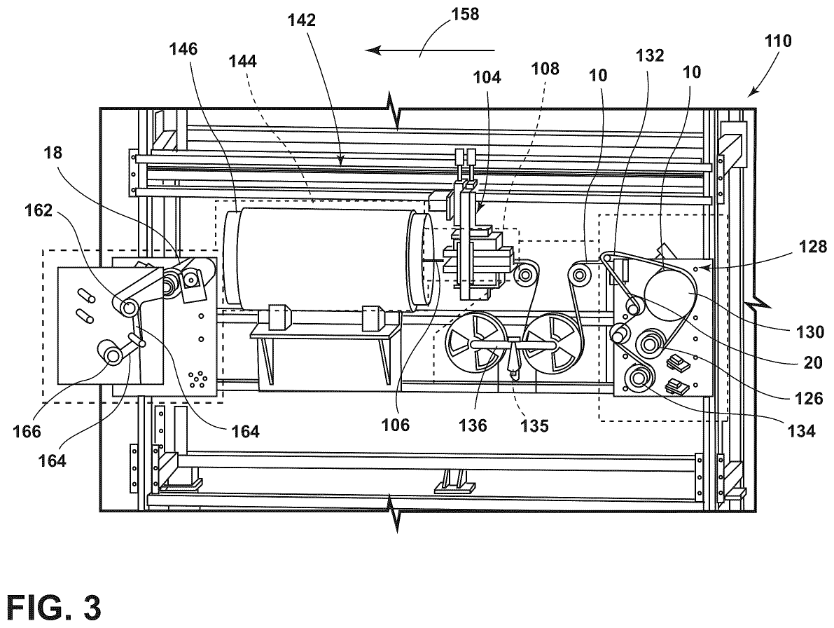

Referring to FIG. 1, a tape green body 10 includes grains of inorganic sinterable material 12, an inorganic hydroxide 14, and a binder 16. The binder 16 acts as an adhesive that holds the grains of inorganic sinterable material 12 and the inorganic hydroxide 14 together until the binder 16 is purposefully removed via burnout of the binder 16 that occurs before sintering. As will be further detailed, the inorganic hydroxide 14 withdraws heat from tape green body 10 during burnout of the binder 16 and helps prevent the tape green body 10 from igniting, which allows for a continuous process to transform the tape green body 10 into a ceramic tape 18 (see FIG. 3) at a conveyance rate that is faster than previously achieved. The constituents of the tape green body 10 of FIG. 1 are not drawn to scale and the figure is not intended to provide a qualitative representation of the interaction between the constituents within the tape green body 10. Rather, FIG. 1 is meant to illustrate that the identified constituents are included in the composition of the tape green body 10.

In embodiments, the inorganic sinterable material 12 is greater than or equal to 75 wt % of the tape green body 10. For example, the inorganic sinterable material 12 can be 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt % 93 wt %, 94 wt %, 95 wt %, 96 wt %, 97 wt %, or more of the tape green body 10, or within any range bound by any two of those values (e.g., from 75 wt % to 95 wt %, from 80 wt % to 85 wt %, and so on). In embodiments, the inorganic hydroxide 14 is less than or equal to 20 wt % of the tape green body 10, such as less than or equal to 7 wt % of the tape green body 10. For example, the inorganic hydroxide 14 can be greater than 0 wt %, 1 wt %, 2 wt %, 3 wt %, 4 wt %, 5 wt %, 6 wt %, 7 wt %, 8 wt %, 9 wt % 10 wt %, 11 wt %, 12 wt %, 13 wt %, 14 wt %, 15 wt %, 16 wt %, 17 wt %, 18 wt %, 19 wt %, or 20 wt % of the tape green body 10, or within any range bound by any two of those values (e.g., from greater than 0 wt % to 20 wt %, from 5 wt % to 15 wt %, from greater than 0 wt % to 7 wt %, from greater than 0 wt % to 5 wt %, and so on).

The inorganic sinterable material 12 can be any material that is inorganic and sinterable. “Sinterable” means that grains of the material can bond together via solid-state diffusion upon being exposed to an environment having a temperature below the melting point of the material. In embodiments, the inorganic sinterable material 12 is or includes one or more of a ceramic material, a glass-ceramic material, a metal, and a synthetic material. Combinations of inorganic sinterable materials 12, such as cermets, are envisioned.

The ceramic material can be monocrystalline or polycrystalline, or a combination of both. Suitable ceramic materials include, without limitation, an oxide, a carbide, a nitride, a boride, an oxynitride, a titanate, a phosphate, a silicate, a sulfide, a fluoride, a carbonate, a zirconate, and a cobaltite. Example inorganic sinterable oxide ceramics include, without limitation, aluminum oxide (Al₂O₃), zirconia (ZrO₂), magnesium oxide (MgO), titanium dioxide (TiO₂), yttrium oxide (Y₂O₃), silicon dioxide (SiO₂), cerium oxide (CeO₂), lanthanum oxide (La₂O₃), iron oxide (Fe₂O₃), and zinc oxide (ZnO). Example inorganic sinterable carbide ceramics include silicon carbide (SiC), tungsten carbide (WC), titanium carbide (TiC), zirconium carbide (ZrC), hafnium carbide (HfC), boron carbide (B₄C), chromium carbide (Cr₃C₂), vanadium carbide (VC), and molybdenum carbide (Mo₂C). Example inorganic sinterable nitride ceramics include silicon nitride (Si₃N₄), aluminum nitride (AlN), boron nitride (BN), titanium nitride (TiN), zirconium nitride (ZrN), hafnium nitride (HfN), vanadium nitride (VN), silicon aluminum nitride (SiAlN), and tantalum nitride (TaN). Example inorganic sinterable boride ceramics include titanium diboride (TiB₂), zirconium diboride (ZrB₂), hafnium diboride (HfB₂), tungsten boride (WB), molybdenum boride (MoB), and chromium diboride (CrB₂). Example inorganic sinterable oxynitride ceramics include silicon oxynitride (SiON), aluminum oxynitride (AlON), zirconium oxynitride (ZrON), titanium oxynitride (TiON), and yttrium oxynitride (YON). Example inorganic sinterable titanates ceramics include barium titanate (BaTiO₃), strontium titanate (SrTiO₃), magnesium titanate (MgTiO₃), barium neodymium titanate (BaNd₂Ti₅O₁₄) and lead titanate (PbTiO₃). Suitable inorganic sinterable phosphate ceramics include beta-tricalcium phosphate, hydroxyapatite, calcium phosphate (Ca₃(PO₄)₂), zirconium phosphate ((ZrPO₄)₂), and aluminum phosphate (AlPO₄). Suitable inorganic sinterable silicate ceramics include forsterite (MgSiO₄), aluminum silicate (Al₂SiO₅), cordierite (Mg₂Al₄Si₅O₁₈), mullite (Al₆Si₂O₁₄), steatite (MgO—SiO₂), garnets, and wollastonite (CaSiO₃). Suitable inorganic sinterable sulfide ceramics include cadmium sulfide (CdS), zinc sulfide (ZnS), lead sulfide (PbS), iron sulfide (FeS), and copper sulfide (Cu₂S). Suitable inorganic sinterable fluoride ceramics include calcium fluoride (CaF₂), magnesium fluoride (MgF₂), and barium fluoride (BaF₂). Suitable inorganic sinterable carbonate ceramics include calcium carbonate (CaCO₃), barium carbonate (BaCO₃), and strontium carbonate (SrCO₃). Suitable inorganic sinterable zirconate ceramics include lithium zirconate (Li₂ZrO₃), calcium zirconate (CaZrO₃), and cerium zirconate (CeZrO₄). Suitable inorganic sinterable cobaltite ceramics include cobalt aluminum oxide (CoAl₂O₄), cobalt chromium oxide (CoCr₂O₄), cobalt magnesium oxide (CoMgO₄), and cobalt nickel oxide (CoNi₂O₄). Other suitable inorganic sinterable ceramics include peroviskites, pyrochlores, ferrites, and sapphire, among others.

In embodiments, the ceramic material of the inorganic sinterable material 12 is or includes an alkali-containing ceramic material. For example, the ceramic material can include alkali metal ions, such as lithium ions (Li⁺), sodium ions (Na⁺), potassium ions (K⁺), and cesium ions (Cs⁺) that occupy interstitial sites in the crystal lattice of the ceramic material. Ceramic materials that include lithium ions are typically referred to as lithium-containing ceramic materials. Ceramic materials that include sodium ions are typically referred to as sodium-containing ceramic materials, and so on. Example lithium-containing ceramic materials that are suitable for the inorganic sinterable material 12 include lithium aluminum silicate (LiAlSiO₄); lithium aluminate (LiAlO₂); lithium titanate (Li₄Ti₅O₁₂); lithium niobate (LiNbO₃); lithium iron phosphate (LiFePO₄); lithium manganese oxide (LiMn₂O₄); a layered rock-salt based phase such as lithium cobalt oxide (LiCoO₂), lithium nickel oxide (LiNiO₂), and derivatives such as LiNiₓMn_{y}Co_{z}AlᵥO₂ where x+y+z+v=1, 0≤x≤1, 0≤y≤1, 0≤z≤1, 0≤v≤1 (including LiNi_{0.8}Mn_{0.1}Co_{0.1}O₂(NMC 811) and LiNi_{0.85}Co_{0.1}Al_{0.05}O₂ (NCA)); lithium vanadium oxide (LiV₃O₈); lithium tungsten oxide (Li₂WO₄); lithium lanthanum titanate (LiLaTiO₃); lithium strontium niobate (LiSrNbO₃); lithium sodium potassium niobate; lithium calcium silicate (Li₂CaSiO₄); lithium magnesium silicate (Li₂MgSiO₄); lithium zirconate (Li₂ZrO₃); lithium germanate (Li₂GeO₃); lithium borate (Li₂B₄O₇); lithium oxide (Li₂O); lithium lanthanum zirconium oxide (LLZO); lithium magnetite (LiFe₅O₈); lithium aluminum titanium phosphate (LATP); and lithium aluminum germanium phosphate (LAGP). Example sodium-containing ceramic materials that are suitable for the inorganic sinterable material 12 include sodium aluminum silicate (NaAlSiO₄), sodium titanate (Na₂TiO₃), sodium niobate (NaNbO₃), sodium iron phosphate (NaFePO₄), sodium cobalt oxide (NaCoO₂), sodium tungstate (Na₂WO₄), sodium zirconate (Na₂ZrO₃), sodium germanate (NaGeO₃), sodium borate (Na₂B₄O₇), sodium phosphate (Na₃PO₄), sodium silicate (Na₂SiO₃), sodium sulfide (Na₂S), sodium bismuth titanate, and sodium fluoride (NaF). Example potassium-containing ceramic materials that are suitable for the inorganic sinterable material 12 include potassium titanate (K₂TiO₃), potassium niobate (KNbO₃), potassium lithium niobate, potassium sodium niobate, potassium sodium strontium niobate, potassium tungstate (K₂WO₄), potassium zirconate (K₂ZrO₃), potassium lanthanum titanate, potassium sodium niobium tungsten oxide, potassium sodium lithium tantalate, potassium sodium niobium oxide, and potassium sodium strontium tungsten oxide.

As mentioned, the tape green body 10 includes an inorganic hydroxide 14. As will be further explained, the presence of the inorganic hydroxide 14 helps to prevent the tape green body 10 from igniting during the burnout of the binder 16 that occurs before sintering. In embodiments, the inorganic hydroxide 14 exhibits an endothermic decomposition, meaning that the inorganic hydroxide 14 requires energy (e.g., absorbs heat) to break down into its constituent parts (e.g., an inorganic oxide and water). For example, the decomposition of magnesium hydroxide (Mg(OH)₂) can generate magnesium oxide (MgO) and water. As a consequence, the tape green body 10 exhibits a peak heat release during burnout of the binder 16 that is less than a peak heat release that the tape green body 10 would exhibit without the inorganic hydroxide 14. Further, the decomposition of the inorganic hydroxide 14 generating water (in vapor state) dilutes oxygen in the environment around the tape green body 10, which further reduces the ability of the tape green body 10 to ignite during burnout of the binder 16.

Differential scanning calorimetry (“DSC”) can be utilized to confirm that the peak heat release that the tape green body 10 with the inorganic hydroxide 14 exhibits is less than a peak heat release that the tape green body 10 would exhibit without the inorganic hydroxide 14. DSC is a thermal analysis technique that measures the heat flow between a sample and a reference material as a function of temperature or time. In the context of the tape green body 10, the peak heat release that the tape green body 10 exhibits during DSC corresponds to the exothermic reaction that occurs during burnout of the binder 16 from the tape green body 10. Due to the presence of the inorganic hydroxide 14, and most dramatically when the inorganic hydroxide 14 exhibits an endothermic decomposition, the peak heat release that the tape green body 10 exhibits during the DSC (and during burnout of the binder 16) is less than the peak heat release that the tape green body 10 would exhibit in the absence of the inorganic hydroxide 14. To provide a number, in embodiments, the peak heat release that the tape green body 10 exhibits is less than or equal to 2 W/g in the presence of an environment of 80% N₂ and 20% O₂.

Examples of suitable inorganic hydroxides 14 include magnesium hydroxide (Mg(OH)₂), calcium hydroxide (Ca(OH)₂), barium hydroxide (Ba(OH)₂), strontium hydroxide (Sr(OH)₂)), aluminum hydroxide (Al(OH)₃), iron(III) hydroxide (Fe(OH)₃), bismuth hydroxide (Bi(OH)₃), nickel hydroxide (Ni(OH)₂), cobalt hydroxide (Co(OH)₂), aluminum oxide hydroxide (AlO(OH)), manganese hydroxide (Mn(OH)₂), zinc hydroxide (Zn(OH)₂), lanthanum hydroxide (La(OH)₃), copper(II) hydroxide (Cu(OH)₂), cadmium hydroxide (Cd(OH)₂), lead(II) hydroxide (Pb(OH)₂), chromium(III) hydroxide (Cr(OH)₃), iron(II) hydroxide (Fe(OH)₂), and thallium(I) hydroxide (TlOH). This list is not exclusive.

As mentioned, the tape green body 10 includes a binder 16. Examples of suitable binders 16 include polyvinyl alcohol (PVA), polyethylene glycol (PEG), hydroxypropyl methylcellulose (HPMC), carboxymethylcellulose (CMC), polyacrylic acid (PAA), polyvinylpyrrolidone (PVP), polymethylmethacrylate (PMMA), polyethylmethacrylate (PEMA), polybutylmethacrylate (PBMA) polyhexylmethacrylate (PHMA), polymethylacrylate (PMA), polyethylacrylate (PEA), polybutylacrylate (PBA) polyhexylacrylate (PHMA), ethyl cellulose, cellulose acetate butyrate (CAB), methyl cellulose, polypropylene carbonate (PPC), polybutylene carbonate (PBC), polypropylene-co-cyclohexene carbonate (PPCC), polyvinyl butyral (PVB), a copolymer containing polystyrene, a co-polymer containing polyisobutylene, and a copolymer containing one or more alkyl (meth)acrylates. Polyesters such as poly(ethylene terephthalate) (PET) and poly(propylene succinate) (PPS) may also be suitable. Likewise, silicones such as polydimethylsiloxane (PDMS) may also be used.

Another advantage to the incorporation of the inorganic hydroxide 14 into the tape green body 10 is that a relatively higher weight percentage of binder 16 can be utilized without burnout of the binder 16 causing the tape green body 10 to ignite. The greater the weight percentage of the binder 16, the stronger the tape green body 10 is, which facilitates removal of the tape green body 10 from a carrier web 20 (see FIG. 3) during the continuous process to manufacture ceramic tape 18 from the tape green body 10. In general, the stronger the tape green body 10 is, the easier it is to handle the tape green body 10, allowing for a thickness 22 of the tape green body 10 to be reduced (thus resulting in a thinner ceramic tape 18). In embodiments, the binder 16 is within a range of from 1 wt % to 10 wt % of the tape green body 10. For example, the binder 16 can be 1 wt %, 2 wt %, 3 wt %, 4 wt %, 5 wt %, 6 wt %, 7 wt %, 8 wt %, 9 wt %, or 10 wt % of the tape green body 10, or within any range bound by any two of those values (e.g., from 2 wt % to 7 wt %, from 3 wt % to 8 wt %, and so on).

In embodiments, the tape green body 10 further includes a plasticizer 24. The incorporation of the plasticizer 24 into the tape green body 10 can improve flexibility of the slurry made to form the tape green body 10 and help prevent cracking of the tape green body 10 during the transformation into the ceramic tape 18. In embodiments, the plasticizer 24 makes up from 1 wt % to 10 wt % of the tape green body 10. For example, the plasticizer 24 can be 1 wt %, 2 wt %, 3 wt %, 4 wt %, 5 wt %, 6 wt %, 7 wt %, 8 wt %, 9 wt %, or 10 wt % of the tape green body 10, or within any range bound by any two of those values (e.g., from 2 wt % to 5 wt %, from 3 wt % to 6 wt %, and so on). Suitable plasticizers 24 include the plasticizer comprises one or more of dibutyl phthalate (DBP), butyl benzyl phthalate (BBP), triethyl citrate (TEC), acetyl tributyl citrate (ATBC), polyethylene glycol (PEG), trioctyl trimellitate (TOTM), polypropylene glycol (PPG), dioctyl terephthalate (DOTP), diisononyl cyclohexane-1,2-dicarboxylate (DINCH), and liquid paraffin. Other plasticizers 24 are envisioned and this list is not exhaustive. The combined weight percentage of the constituents of the tape green body 10 specifically mentioned herein is less than or equal to 100 wt %.

In embodiments, the tape green body 10 further includes a dispersant 26. Incorporation of the dispersant 26 improves the dispersion of the grains of inorganic sinterable material 12 within the tape green body 10 and, thus, resists agglomeration of the grains of inorganic sinterable material 12. Suitable dispersants 26 include polyacrylic acid (PAA), sodium alginate, hydroxypropyl methylcellulose (HPMC), carboxymethyl cellulose (CMC), sodium dodecylbenezenesulfonate (SDBS), and sodium lignosulfonate. Other dispersants 26 are envisioned and this list is not exhaustive. The presence of the inorganic hydroxide 14 in the tape green body 10 additionally allows for a higher weight percentage of the dispersant 26 to be included, which can improve the quality of the ceramic tape 18.

In embodiments, the tape green body 10 further includes one or more additives 28 not already herein described. For example, the one or more additives 28 can include any one or more of a surfactant, a rheology modifier, an antifoaming agent, a deflocculant, and a sintering aid to enhance grain growth and densification during sintering. Example sintering aids include magnesia (MgO), yttria (Y₂O₃), zirconia (ZrO₂), ceria (CeO₂), other rare earth oxides such as La₂O₃, and silicon carbide (SiC). Another example is lithium carbonate (Li₂O₃), which decomposes during sintering into lithium oxide (Li₂O) and carbon dioxide (CO₂), and the lithium oxide (Li₂O) promotes densification of the ceramic tape 18.

The tape green body 10 further includes a width 30 and a length 32, in addition to the thickness 22. The width 30 is the distance between a first side 34 and a second side 36 of the tape green body 10. In embodiments, the width 30 is within a range of from 0.5 mm to 600 mm. For example, the width 30 can be 0.5 mm, 1 mm, 5 mm, 10 mm, 20 mm, 30 mm, 40 mm, 50 mm, 60 mm, 70 mm, 80 mm, 90 mm, 100 mm, 110 mm, 120 mm, 130 mm, 140 mm, 150 mm, 160 mm, 170 mm, 180 mm, 190 mm, 200 mm, 210 mm, 220 mm, 230 mm, 240 mm, 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, 410 mm, 420 mm, 430 mm, 440 mm, 450 mm, 460 mm, 470 mm, 480 mm, 490 mm, 500 mm, 510 mm, 520 mm, 530 mm, 540 mm, 550 mm, 560 mm, 570 mm, 580 mm, 590 mm, or 600 mm, or within any range bound by any two of those values (e.g., from 1 mm to 50 mm, from 20 mm to 100 mm, from 100 mm to 450 mm, and so on). However, the width 30 can be less than 0.5 mm or greater than 600 mm.

In embodiments, the length 32 of the tape green body 10, being suitable for a continuous rather than batch processes to transform the tape green body 10 into the ceramic tape 18, is greater than or equal to 300 cm. The length 32 can be within a range of from 300 cm to 60 m (or greater). For example, the length 32 can be 300 cm, 500 cm, 1 m, 5 m, 10 m, 15 m, 20 m, 25 m, 30 m, 35 m, 40 m, 45 m, 50 m, 55 m, 55 m, 60 m, 100 m, 200 m, 300 m, 400 m, 500 m, 1 km, 2 km, 3 km, 4 km, or 5 km, or within any range bound by any two of those values (e.g., from 15 m to 40 m, from 20 m to 55 m, from 100 m to 4 km, and so on). The length 32 can be less than 300 cm as well. There is theoretically no upward limit to the length 32 of the tape green body 10. The length 32 is generally orthogonal to the width 30 of the tape green body 10.

The thickness 22 of the tape green body 10 is the distance between a first primary surface 38 and a second primary surface 40 of the tape green body 10. In embodiments, the thickness 22 is within a range of from 10 μm to 250 μm. For example, the thickness 22 can be 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, or 250 μm, or within any range bound by any two of those values (e.g., from 20 μm to 220 μm, from 50 μm to 190 μm, and so on). It is envisioned that the thickness 22 can be less than 10 μm or greater than 250 μm.

As mentioned, in a continuous process to transform the tape green body 10 into the ceramic tape 18, the burnout of the binder 16 is prone to cause the tape green body 10 to ignite (in the absence of the inorganic hydroxide 14 as herein described). The faster the continuous process is, the more likely the tape green body 10 would be to ignite. The incorporation of the inorganic hydroxide 14 into the tape green body 10 allows the continuous process to proceed faster without causing the tape green body 10 to ignite. Without being bound by theory, it is believed that at least a portion of the inorganic hydroxide 14 decomposes endothermically while burnout of the binder 16 causes the binder 16 to decompose exothermically. The inorganic hydroxide 14 thus withdraws heat from the tape green body 10 that might otherwise cause the tape green body 10 to ignite. Further, decomposition of the inorganic hydroxide 14 generates water vapor. The water vapor dilutes oxygen in the environment of the tape green body 10 and thus further reduces the ability of the tape green body 10 to ignite. These mechanisms allow the process to be conducted faster than in the absence of the inorganic hydroxide 14. Stated another way, the tape green body 10 with the inorganic hydroxide 14 can be directed through a binder burnout zone of the process at a conveyance rate that is faster compared to if no inorganic hydroxide 14 was included. In embodiments, the tape green body 10 exhibits a lack of ignition during a continuous process of transforming the tape green body 10 into the ceramic tape 18 at a conveyance rate of greater than or equal to 70 mm/min. In embodiments, the conveyance rate is 70 mm/minute, 100 mm/minute, 200 mm/minute, 300 mm/minute, 400 mm/minute, 500 mm/minute, 600 mm/minute, 700 mm/minute, 800 mm/minute, 900 mm/minute, 1000 mm/minute, 1100 mm/minute, 1200 mm/minute, 1300 mm/minute, 1400 mm/minute, or 1500 mm/minute, or within any range bound by any two of those values (e.g., from 100 mm/minute to 500 mm/minute, from 200 mm/minute to 600 mm/minute, and so on). In embodiments, the conveyance rate (without ignition of the tape green body 10) is greater than 1500 mm/minute.

The inorganic hydroxide 14 and the binder 16 can be selected to optimize the conveyance rate without causing ignition of the tape green body 10. Inorganic hydroxides 14 decompose over at least a decomposition temperature range that includes a decomposition onset temperature and peak decomposition temperature. The temperature at which the tape green body 10 (in the absence of the inorganic hydroxide 14) exhibits peak heat release varies depending upon the binder 16 chosen. In embodiments, the binder 16 and the inorganic hydroxide 14 are selected so that the temperature at which the tape green body 10 (in the absence of the inorganic hydroxide 14) exhibits peak heat release falls within the decomposition temperature range of the inorganic hydroxide 14. It is believed that doing so improves the heat withdrawal benefit that decomposition of the inorganic hydroxide 14 provides and thus leads to faster conveyance rates.

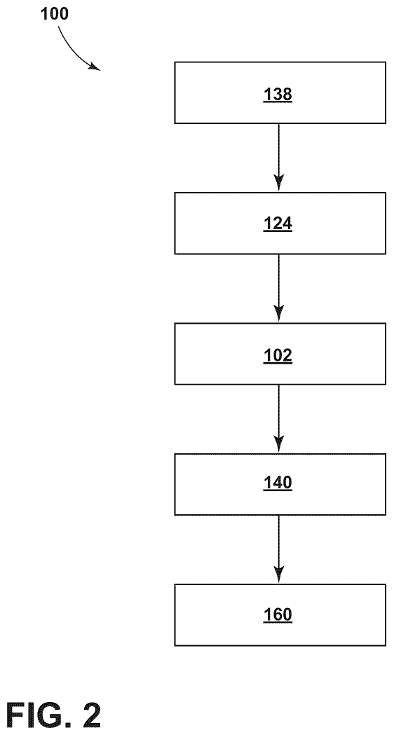

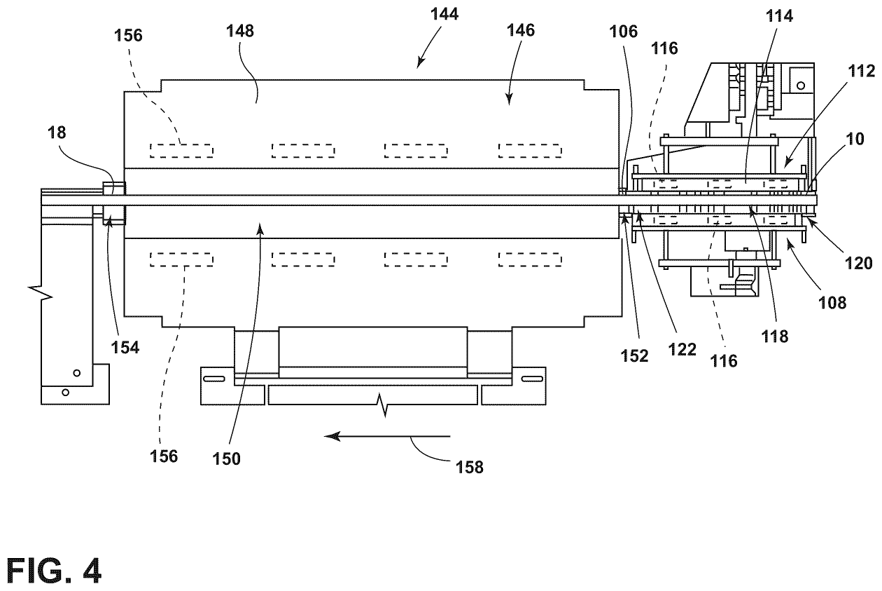

Referring now to FIGS. 2-4, a method 100 of manufacturing the ceramic tape 18 from the tape green body 10 is herein described. “Continuous” for purposes of the method 100 means that any particular step of the method 100 occurs without interruption until the length 32 of the tape green body 10 has been transformed into the ceramic tape 18. In a batch process, the entire length of the tape green body experiences the same environment at the same time.

In embodiments, the method 100 further includes a continuous binder burnout step 102. The continuous binder burnout step 102 includes feeding the tape green body 10 through a burnout heating zone 104. The burnout heating zone 104 has a burnout temperature sufficient to burn out at least a portion of the binder 16 from the tape green body 10. The continuous binder burnout step 102 transforms the tape green body 10 into a debound tape 106, which is a precursor to the ceramic tape 18. The tape green body 10 is continuously connected to the debound tape 106, as the tape material traverses the burnout heating zone 104. Although all or a portion of the binder 16 is removed from the tape green body 10 during the continuous binder burnout step 102, the debound tape 106 may still hold together, such as via char of the burned binder 16 or by interweaving or bonding between the inorganic sinterable material 12, or by other means (e.g., electrostatic forces and/or air pressures). In general, the debound tape 106 includes the grains of inorganic material with very little or no organic binder 16 remaining.

In embodiments, the tape green body 10 is fed through the burnout heating zone 104 (including the furnace, etc.) at any of the conveyance rates previously described (e.g., greater than or equal to 70 mm/minute, greater than or equal to 100 mm/minute, and so on) without the tape green body 10 igniting. The presence of the inorganic hydroxide 14 within the tape green body 10 allows for faster conveyance rates through the burnout heating zone 104 to be achieved without the tape green body 10 igniting during the continuous binder 16 burnout step compared to tape green bodies that do not incorporate the inorganic hydroxide 14.

In embodiments, the burnout temperature is within a range of from 150° C. to 600° C. For example, the burnout temperature can be 150° C., 200° C., 250° C., 300° C., 350° C., 400° C., 450° C., 500° C., 550° C., or 600° C., or within any range bound by any two of those values (e.g., from 300° C. to 400° C., from 250° C. to 350° C., and so on). The burnout temperature is less than the sintering temperature.

In embodiments, the continuous binder burnout step 102 is performed at a binder removal station 108 of a system 110 configured for the transformation of the tape green body 10 into the ceramic tape 18 in a continuous process. The binder removal station 108 includes a furnace 112 with an insulated housing 114 with one or more heating elements 116 disposed therein that delivers heat to a channel 118 to achieve the burnout temperature. The tape green body 10 is directed into an entrance 120 into the channel 118. At least a portion of the binder 16 is removed from the tape green body 10 within the channel 118 forming the debound tape 106 that exits the channel 118 through an exit 122. In some embodiments, some sintering (e.g., shrinkage, increase in density, decrease in porosity, etc.) of the grains of the inorganic sinterable material 12 may occur during traversal through the binder removal station 108.

In embodiments, the method 100 further includes a continuous feed step 124. The continuous feed step 124 occurs before the continuous binder burnout step 102. The continuous feed step 124 includes feeding the tape green body 10 from a source 126 of the tape green body 10 to the burnout heating zone 104. The source 126 of the tape green body 10 can be a spool of the length 32 of the tape green body 10 wrapped therearound. In such embodiments, feeding the tape green body 10 comprises unwinding the tape green body 10 from the spool. In embodiments, the source 126 of the tape green body 10 is another station on a manufacturing line that continuously produces the tape green body 10.

In terms of the system 110, the source 126 can include the tape green body 10 disposed upon the carrier web 20. The system 110 can further include a carrier web removal station 128 with a tension isolator 130 and a peeler 132. The tension isolator 130 and the peeler 132 separate the carrier web 20 from tape green body 10 without damaging the tape green body 10. The carrier web 20, now separated from the tape green body 10, is collected on an uptake reel 134. A tension control system 135 with a tension dancer 136 provides enough tension to the tape green body 10 to limit distortion during the continuous binder burnout step 102.

In embodiments, the method 100 further includes a composition determination step 138. The composition determination step 138 occurs before the continuous feed step 124 and the continuous binder burnout step 102. The composition determination step 138 includes selecting the inorganic hydroxide 14 and the binder 16 of the tape green body 10 as a function of the decomposition temperature range of the inorganic hydroxide 14 and the temperature at which the tape green body 10 exhibits peak heat release with the binder 16 but in the absence of the inorganic hydroxide 14. In particular, the temperature at which the tape green body 10 exhibits peak heat release with the binder 16 but in the absence of the inorganic hydroxide 14 falls within the decomposition temperature range of the inorganic hydroxide 14.

The method 100 includes a continuous sintering step 140 that occurs after the continuous binder burnout step 102. The continuous sintering step 140 includes feeding the debound tape 106 through a sintering heating zone 142. After leaving the burnout heating zone 104, the debound tape 106 is directed to the sintering heating zone 142. The sintering heating zone 142 has a temperature that is sufficient to sinter at least partially the debound tape 106 into the ceramic tape 18.

To provide the sintering heating zone, the system 110 can include a sintering station 144 that provides the sintering heating zone 142. More particularly, the sintering station 144 can include a furnace 146 with an insulated housing 148. The insulated housing 148 includes a plurality of internal walls 150 that define a channel 150 that extends through the furnace 146 between an entrance 152 and an exit 154. After exiting out of the binder removal station 108 through the exit 122, the debound tape 106 is directed into the channel 150 of the sintering station 144 through the entrance 152 thereof. While within the channel 150, one or more heating elements 156 generate heat that provides the temperature sufficient to at least partially sinter the debound tape 106 to form the ceramic tape 18. The ceramic tape 18 proceeds out through the exit 154. Depending on the temperature profile that the debound tape 106 is exposed to during the continuous sintering step 140, upon exiting the furnace 146, the ceramic tape 18 may be fully sintered or partially sintered. Whether the ceramic tape 18 is partially sintered or fully sintered, the porosity of the ceramic tape 18 is less than the porosity of both the debound tape 106 and the tape green body 10 due to the sintering that occurs within furnace 146. The heating elements 156 can be independently controllable to maintain a predetermined temperature profile throughout the sintering heating zone 142. The tape green body 10 is directed in a direction 158 through the burnout heating zone 104, the binder removal station 108, the sintering heating zone 142, and the sintering station 144. In embodiments, the debound tape 106 is fed through the sintering heating zone 142 (including the furnace 146, etc.) at any of the conveyance rates previously described (e.g., greater than or equal to 70 mm/minute, greater than or equal to 1500 mm/minute, and so on) without the tape green body 10 igniting.

In embodiments, the sintering temperature is within a range of from 500° C. and 3200° C. For example, the sintering temperature can be 500° C., 600° C., 700° C., 800° C., 900° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., 3000° C., 3100° C., or 3200° C., or within any range bound by any two of those values (e.g., from 1000° C. to 2000° C., from 800° C. to 1500° C., from 800° C. to 1700° C., and so on).

In embodiments, the continuous binder burnout step 102 is performed at the sintering station 144. For example, the furnace 146 of the sintering station 144 can dedicate certain of the heating elements 156 to provide the burnout heating zone 104 and to achieve the burnout temperature. Another benefit of the incorporation of the inorganic hydroxide 14 into the tape green body 10, and a consequence of the higher conveyance rates achievable without igniting the tape green body 10, is that the burnout heating zone 104 can be reduced in size.

However, utilizing the binder removal station 108 with the heating elements 116 dedicated to remove the binder 16, independent of heating elements 156 of the furnace 146 of the sintering station 144, may allow for greater control over removal of the binder 16 and thus reduce the likelihood that the tape green body 10 will ignite.

In embodiments, the method 100 further includes a continuous uptake step 160. The continuous uptake step 160 occurs after the continuous sintering step 140. The continuous uptake step 160 includes winding the ceramic tape 18 upon a reel 162. Support material 164 can be taken from a reel 166 and simultaneously added beneath the ceramic tape 18 upon the reel 162. When the continuous feed step 124 begins by feeding the tape green body 10 from a reel of the tape green body 10 as the source 126, and the continuous uptake step 160 ends with the winding of the ceramic tape 18 upon the reel 162, the method 100 can be said to be a continuous roll-to-roll sintering process.

### EXAMPLE

Examples 1 and 2, and Comparative Examples 1-4—Six batch compositions were prepared with the intention of casting each composition into a tape green body and, subsequently, sintering into a ceramic tape. The weight percentages of the components of the compositions are set forth in Table 1 below. All compositions included grains of lithium cobalt oxide (LiCoO₂) as inorganic sinterable material, either from Source 1 or Source 2. Examples 1 and 2 further included magnesium hydroxide as the inorganic hydroxide, while Comparative Examples 1-4 did not.

TABLE 1

| | Comp. | Comp. | | Comp. | Comp. | |
|---|---|---|---|---|---|---|
| | Exam- | Exam- | Exam- | Exam- | Exam- | Exam- |
| | ple 1 | ple 2 | ple 1 | ple 3 | ple 4 | ple 2 |
| lithium | 100 | 98.148 | 95.127 | — | — | — |
| cobalt | | | | | | |
| oxide | | | | | | |
| (LiCoO₂), | | | | | | |
| Source 1 | | | | | | |
| (wt %) | | | | | | |
| lithium | — | — | — | 100 | 98.148 | 95.127 |
| cobalt | | | | | | |
| oxide | | | | | | |
| (LiCoO₂), | | | | | | |
| Source 2 | | | | | | |
| (wt %) | | | | | | |
| lithium | — | 1.852 | 1.889 | — | 1.852 | 1.889 |
| carbonate | | | | | | |
| (Li₂CO₃) | | | | | | |
| (wt %) | | | | | | |
| Magnesium | — | — | 2.983 | — | — | 2.983 |
| hydroxide | | | | | | |
| (Mg(OH)₂) | | | | | | |
| (wt %) | | | | | | |
| Media size | 2 | 2 | 2 | 1 | 1 | 1 |
| (mm) | | | | | | |
| Milling | 3 | 3 | 3 | 6 | 6 | 6 |
| time (h) | | | | | | |
| Mean | 0.410 | 0.405 | 0.412 | 0.453 | 0.552 | 0.461 |
| particle | | | | | | |
| size, | | | | | | |
| d₅₀ (μm) | | | | | | |

Each of the raw materials were subjected to attrition milling to reduce particle size for sintering and to intimately mix the constituents. The attrition milling was conducted on a Union Process Mill with a 1 L polymer lined tank. The charges into the mill consisted of 400 g of the inorganic raw materials, 2600 g of yttria stabilized zirconia milling media, and 360 mL of isopropyl alcohol. The contents were churned at 2000 rpm with a zirconia impeller. The milling media size and time were selected to yield powders with similar mean particle size. The details of the media size, the milling time, and the resulting mean particle size are set forth in Table 1 above. Particle sizes were measured using a Microtrac S3500 instrument. Each slurry was dried and powder separated from the milling media with the assistance of a sieve screen.

Each composition was then cast into a tape green body. More specifically, the powders were dispersed in solvent consisting of methylethyl ketone and toluene for approximately 24 h prior to addition of the organic components (e.g., a binder, plasticizer, and dispersant). Casting was performed to give a thickness for the tape green body within a range of from 30 μm to 35 μm. The dried tape green bodies each consisted of 93.17% of inorganics, 4.29% of Butvar B-76 polyvinyl butyral binder from Eastman, 1.27% Hypermer KD-1 dispersant from Croda International, Plc, and 1.27% dibutyl phthalate as a plasticizer.

Each tape green body representing Examples 1 and 2 and Comparative Examples 1-4 were subjected to DSC analysis to determine peak heat release. Each tape green body was subjected to an environment of 80% N₂ and 20% O₂, except for Comparative Example 2, for which the environment was air. The peak heat release and the temperature at which the peak heat release occurred for each tape green body is set forth in Table 2 below.

TABLE 2

| | Comp. | Comp. | Exam- | Comp. | Comp. | Exam- |
|---|---|---|---|---|---|---|
| | Ex. 1 | Ex. 2 | ple 1 | Ex. 3 | Ex. 4 | ple 2 |
| Sample | 40 | 10 | 40 | 40 | 40 | 40 |
| weight | | | | | | |
| (mg) | | | | | | |
| Environment | 80% N₂ + | Air | 80% N₂ + | 80% N₂ + | 80% N₂ + | 80% N₂ + |
| | 20% O₂ | | 20% O₂ | 20% O₂ | 20% O₂ | 20% O₂ |
| Temperature | 255.1 | 265.5 | 264.2 | 251.8 | 250.6 | 266.6 |
| of peak | | | | | | |
| heat release | | | | | | |
| (° C.) | | | | | | |
| Peak heat | 3.31 | 2.80 | 0.84 | 4.37 | 6.34 | 1.34 |
| release | | | | | | |
| (W/g) | | | | | | |

As the results reproduced in Table 2 above show, Examples 1 and 2 with the magnesium hydroxide (Mg(OH₂)) exhibited a peak heat release that was much lower than the Comparative Examples 1-4 without any inorganic hydroxide. More specifically, the peak heat release of Comparative Example 1 was over 3.9 times the peak heat release of Example 1. Similarly, the peak heat release of Comparative Example 3 was over 3.2 times the peak heat release of Example 2. The decrease in peak heat release cannot be attributed to the presence of lithium carbonate (Li₂CO₃) in Examples 1 and 2, as Comparative Examples 2 and 4 both included lithium carbonate (Li₂CO₃) as well, and the peak heat release difference was still apparent. The peak heat release of Comparative Example 2 was over 3.3 times the peak heat release of Example 1, and the peak heat release of Comparative Example 4 was over 4.7 times the peak release of Example 2.

The source lithium cobalt oxide (LiCoO₂) also appears to affect peak heat release. The peak heat releases for Comparative Examples 1 and 2 and Example 1, which all included lithium cobalt oxide (LiCoO₂) from Source 1, were all lower than the peak heat releases for Comparative Examples 3 and 4 and Example 2, which all included lithium cobalt oxide (LiCoO₂) from Source 2.

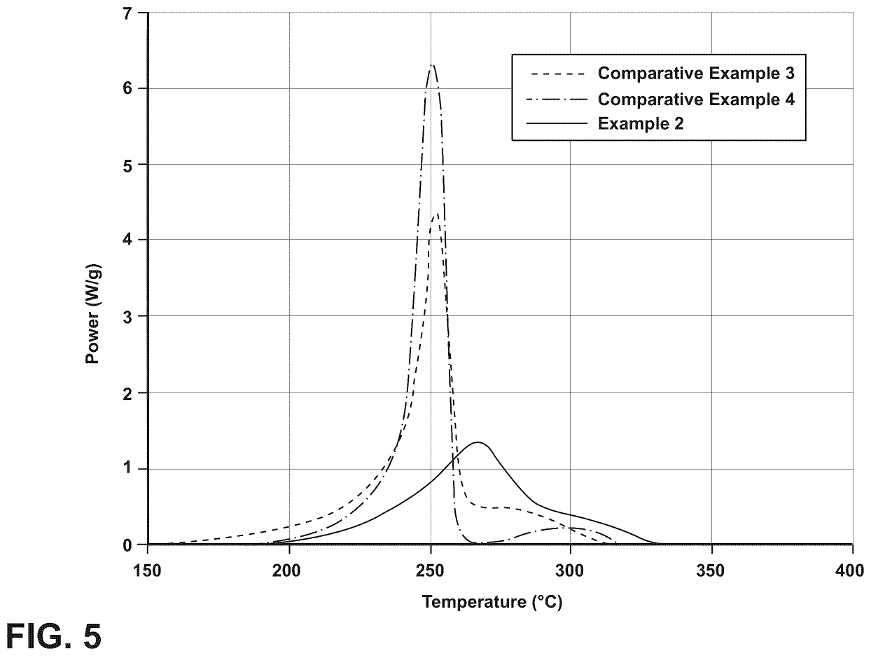

The heat release as a function of temperature for Comparative Examples 3 and 4 and Example 2 during the DSC analysis were recorded. The resulting DSC curves for each are reproduced at FIG. 5. As the DSC curves show, the heat releases from Comparative Examples 3 and 4 accelerated dramatically as temperature approached 250° C. where peak heat release occurred. In contrast, the heat release from Example 2 did not accelerate dramatically toward about 270° C. where peak heat release occurred. In short, Example 2 exhibited a slower rate of heat release increase, the peak heat release occurred at a higher temperature, and the heat release occurred over a wider temperature range than Comparative Examples 3 and 4. The slower heat release for Example 2 means that the tape green body is less able to ignite, which permits for a faster conveyance rate.

The maximum conveyance rate through a binder burnout heating zone before the tape green body ignited was determined for the tape green bodies of Comparative Example 4 and Example 2. The equipment used for the tests were a laboratory scale rapid sintering system that included two symmetric and opposed air bearings that measure 280 mm in length and were are separated by approximately 1 cm for a binder burnout heating zone and an immediately adjacent 1 m long tube furnace for a sintering heating zone. A drum with a programmable motor was located approximately 1 m away from the exit of the tube furnace to pull and wind the tape. For these examples, the binder burnout heating zone was programmed with a linear temperature ramp from inlet to outlet of 225° C. to 325° C. The rate of gas flow into upper and lower air bearings was 6 L/min each of air. An alumina ribbon attached to the winding drum was fed through the furnace, binder-burnout zone to a sample loading platform. The alumina ribbon measured approximately 50 mm in width and was 40 m thick. Strips of the tape green bodies for Comparative Example 4 and Example 2 were cut to 380 mm length and 50 mm width, released from the polymer carrier and laid onto the end of the alumina ribbon. Strips of the tape green bodies were pulled into the binder burnout heating zone. Multiple runs were performed adjusting the conveyance rate through the binder burnout heating zone upward or downward to identify the threshold above which ignition of the tape green body occurs. The results are presented in Table 3 below.

TABLE 3

| Conveyance | | |
|---|---|---|
| Rate | | |
| (mm/min) | Comp. Ex. 4 | Example 2 |
| 50.8 | Survived | — |
| 63.5 | Survived | — |
| 69.9 | Survived | — |
| 76.2 | Ignited | — |
| 101.6 | Ignited | Survived |
| 108.0 | — | Survived |
| 114.3 | — | Ignited |
| 127.0 | — | Ignited |
| 203.2 | Ignited | Ignited |

As the data in Table 3 show, the tape green body of Example 2 with the magnesium hydroxide (Mg(OH)₂)) survived a conveyance rate of 108 mm/min, while the tape green body of Comparative Example 4 without any inorganic hydroxide suffered ignition at that conveyance rate. The fastest conveyance rate that the tape green body of Comparative Example 4 survived was 69.9 mm/min. Thus, the tape green body of Example 2 survived a conveyance rate through a binder burnout heating zone that is more than 1.5 times as fast as the fastest conveyance rate that Comparative Example 4 survived.

Although incorporation of magnesium hydroxide (Mg(OH)₂)) as the inorganic hydroxide demonstrated beneficial results, it is believed that the conveyance rate could be improved with other inorganic hydroxides. The decomposition onset temperature of magnesium hydroxide (Mg(OH)₂)) is thought to be about 325° C. The peak decomposition temperature is about 419° C. The decomposition temperature range thus is at least from 325° C. to about 419° C. However, the tape green body in the absence of the magnesium hydroxide (Mg(OH)₂)) with the polyvinyl butyral binder (Comparative Example 4) exhibits peak heat release at 255° C., according to the thermogram of FIG. 5. The peak heat release of the tape green body without magnesium hydroxide (Mg(OH)₂)) occurs outside of the decomposition temperature range of magnesium hydroxide (Mg(OH)₂)). Other inorganic hydroxides such as aluminum hydroxide (Al(OH)₃), nickel hydroxide (Ni(OH)₂), and cobalt hydroxide (Co(OH)₂) have lower decomposition onset temperatures than magnesium hydroxide (Mg(OH)₂)) and are more likely to provide a decomposition temperature range within which the peak heat release of the tape green body of Comparative Example 4 falls. Thus, those inorganic hydroxides are more likely to better withdraw heat during burnout of the polyvinyl butyral binder and provide faster conveyance rates without ignition of the tape green body.

Examples 3A-3E—For Examples 3A-3E, DSC analyses were performed on various potential constituents of a tape green body. Example 3A analyzes a polymer alone, specifically polypropylene carbonate (PPC), as representative of a binder for a tape green body. Example 3B analyzed the PPC polymer in the presence of lithium cobalt oxide (LiCoO₂). Example 3C analyzed PPC in the presence of magnesium hydroxide (Mg(OH)₂). Example 3D analyzed PPC in the presence of aluminum hydroxide (Al(OH)₃). Example 3E analyzed PPC in the presence of manganese dioxide (MnO₂).

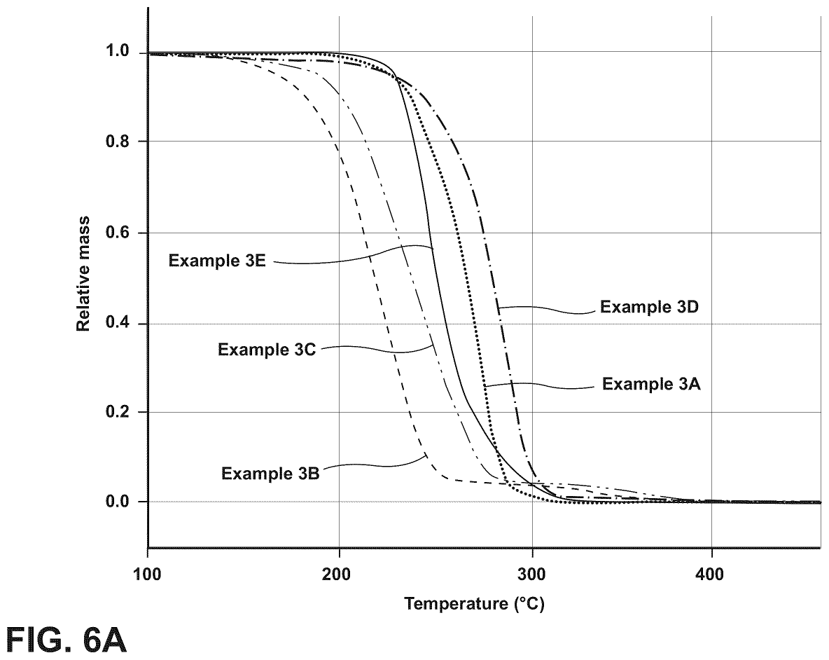

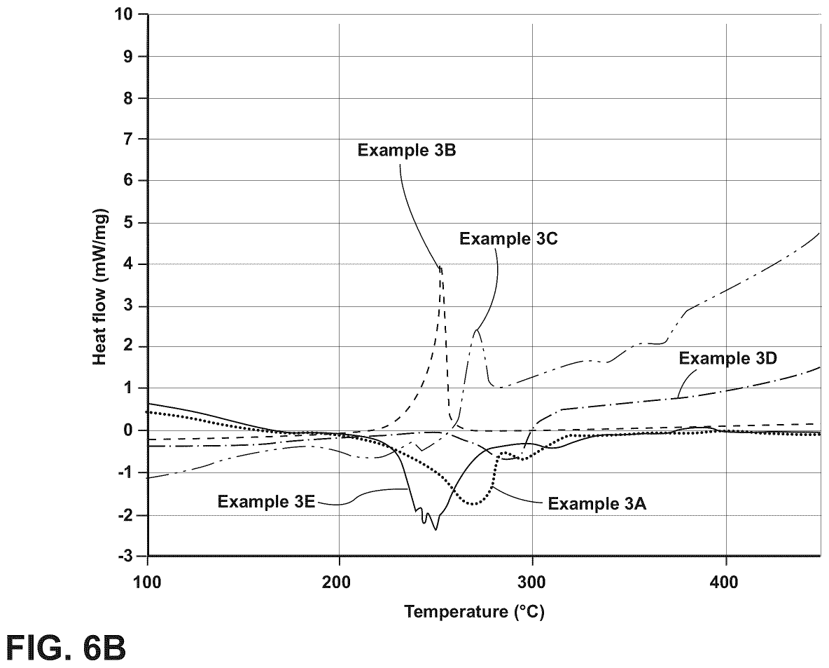

The results of the DSC analyses are reproduced in FIGS. 6A and 6B. FIG. 6A is a thermogravimetric (TGA) curve that plots the mass of the materials being analyzed as a function of temperature.

FIG. 6B is a DSC curve that plots heat release as a function of temperature for the materials being analyzed. The DSC curve for Example 3A (PPC alone) reveals that the degradation of PPC is endothermic and indicated depolymerization via unzipping of the polymer chains. That signature contrasts with other polymers such as polyvinyl butyral that have an exothermic degradation, which signifies degradation via chain scission. The DSC curve for Example 3B (PPC with lithium cobalt oxide) shows that the decomposition turns exothermic. The DSC curve for Example 3C (PPC with magnesium hydroxide) shows that the decomposition again turns exothermic, which may demonstrate that magnesium hydroxide (Mg(OH)₂) is not the best inorganic hydroxide to withdraw heat from the decomposition of the particular polymer PPC. The DSC curve for Example 3D (PPC with aluminum hydroxide) shows an endothermic heat release profile, which may indicate that aluminum hydroxide (Al(OH)₃) is a better inorganic hydroxide to withdraw heat from the decomposition of the particular polymer PPC. Finally, the DSC curve for Example 3E (PPC with magnesium dioxide) shows an endothermic heat release profile that significantly overlaps in temperature range with the exothermic heat release profile of Example 3B (PPC with lithium cobalt oxide), demonstrating that, although not an inorganic hydroxide, magnesium dioxide (MnO₂) may well be a suitable additive to withdraw heat from the exothermic decomposition of PPC with lithium cobalt oxide (LiCoO₂). The magnesium dioxide (MnO₂) was added to the PPC at only 500 ppm.

What is claimed is:

1. A tape green body comprising:
grains of inorganic sinterable material;
from greater than 0 wt % to 7 wt % of an inorganic hydroxide; and
a binder.

2. The tape green body of claim 1, wherein:
the inorganic sinterable material is greater than or equal to 75 wt % of the tape green body.

3. The tape green body of claim 1, wherein
(i) the inorganic hydroxide is from greater than 0 wt % to 5 wt % of the tape green body; and/or
(ii) the inorganic sinterable material comprise one or more of a ceramic material, a glass-ceramic material, or a metal.

4. The tape green body of claim 1, wherein:
the inorganic sinterable material comprise one or more of a ceramic material, a glass-ceramic material, or a metal.

5. 4. The tape green body of claim 1, wherein
inorganic sinterable material comprises a ceramic material, and the ceramic material comprises one or more of an oxide, a carbide, a nitride, a boride, an oxynitride, a titanate, a phosphate, a silicate, a sulfide, a fluoride, a carbonate, a zirconate, and a cobaltite.

6. The tape green body of claim 1, wherein
the inorganic sinterable material comprises an alkali-containing ceramic material, and alkali-containing ceramic material is a lithium-containing ceramic material or a sodium-containing ceramic material.

7. The tape green body of claim 6, wherein
the lithium-containing ceramic material is one or more of lithium aluminum silicate (LiAlSiO₄); lithium aluminate (LiAlO₂); lithium titanate (Li₄Ti₅O₁₂); lithium niobate (LiNbO₃); lithium iron phosphate (LiFePO₄); lithium manganese oxide (LiMn₂O₄); lithium cobalt oxide (LiCoO₂); lithium nickel oxide (LiNiO₂); LiNiₓMn_{y}Co_{z}AlᵥO₂ where x+y+z+v=1, 0≤x≤1, 0≤y≤1, 0≤z≤1, 0≤v≤1; lithium vanadium oxide (LiV₃O₈); lithium tungsten oxide (Li₂WO₄); lithium lanthanum titanate (LiLaTiO₃); lithium strontium niobate (LiSrNbO₃); lithium sodium potassium niobate; lithium calcium silicate (Li₂CaSiO₄); lithium magnesium silicate (Li₂MgSiO₄); lithium zirconate (Li₂ZrO₃); lithium germanate (Li₂GeO₃); lithium borate (Li₂B₄O₇); lithium oxide (Li₂O); lithium lanthanum zirconium oxide (LLZO); lithium magnetite (LiFe₅O₈); lithium aluminum titanium phosphate (LATP); and lithium aluminum germanium phosphate (LAGP).

8. The tape green body of claim 1, wherein:
(i) the inorganic hydroxide exhibits an endothermic decomposition; and/or
(ii) the inorganic hydroxide comprises one or more of magnesium hydroxide (Mg(OH)₂), calcium hydroxide (Ca(OH)₂), barium hydroxide (Ba(OH)₂), strontium hydroxide (Sr(OH)₂)), aluminum hydroxide (Al(OH)₃), iron(III) hydroxide (Fe(OH)₃), bismuth hydroxide (Bi(OH)₃), nickel hydroxide (Ni(OH)₂), cobalt hydroxide (Co(OH)₂), aluminum oxide hydroxide (AlO(OH)), manganese hydroxide (Mn(OH)₂), zinc hydroxide (Zn(OH)₂), lanthanum hydroxide (La(OH)₃), copper(II) hydroxide (Cu(OH)₂), cadmium hydroxide (Cd(OH)₂), lead(II) hydroxide (Pb(OH)₂), chromium(III) hydroxide (Cr(OH)₃), iron(II) hydroxide (Fe(OH)₂), and thallium(I) hydroxide (TlOH)

9. The tape green body of claim 1, wherein
the tape green body exhibits a peak heat release during differential scanning calorimetry that is less than a peak heat release that the tape green body would exhibit without the inorganic hydroxide.

10. The tape green body of claim 9, wherein
the peak heat release that tape green body exhibits is less than or equal to 2 W/g in the presence of an environment of 80% N₂ and 20% O₂.

11. The tape green body of claim 1, wherein
the binder comprises one or more of polyvinyl alcohol (PVA), polyethylene glycol (PEG), hydroxypropyl methylcellulose (HPMC), carboxymethylcellulose (CMC), polyacrylic acid (PAA), polyvinylpyrrolidone (PVP), polymethylmethacrylate (PMMA), polyethylmethacrylate (PEMA), polybutylmethacrylate (PBMA) polyhexylmethacrylate (PHMA), polymethylacrylate (PMA), polyethylacrylate (PEA), polybutylacrylate (PBA) polyhexylacrylate (PHMA), ethyl cellulose, cellulose acetate butyrate (CAB), methyl cellulose, polypropylene carbonate (PPC), polybutylene carbonate (PBC), polypropylene-co-cyclohexene carbonate (PPCC), polyvinyl butyral (PVB), a copolymer containing polystyrene, a co-polymer containing polyisobutylene, and a copolymer containing alkyl (meth)acrylates.

12. The tape green body of claim 1, wherein
the inorganic hydroxide decomposes over at least a decomposition temperature range of from a decomposition onset temperature to a peak decomposition temperature; and
the tape green body without the inorganic hydroxide exhibits a peak heat release at a temperature that is within the decomposition temperature range.

13. The tape green body of claim 1 further comprising:
a plasticizer and/or a dispersant.

14. The tape green body of claim 13 wherein
the plasticizer comprises one or more of dibutyl phthalate (DBP), butyl benzyl phthalate (BBP), triethyl citrate (TEC), acetyl tributyl citrate (ATBC), polyethylene glycol (PEG), trioctyl trimellitate (TOTM), polypropylene glycol (PPG), dioctyl terephthalate (DOTP), diisononyl cyclohexane-1,2-dicarboxylate (DINCH), and liquid paraffin.

15. The tape green body of claim 1 further comprising:
an additive,
wherein, the additive is a sintering aid.

16. The tape green body of claim 15, wherein
the sintering aid comprises one or more of cerium oxide, manganese dioxide (MnO₂), and lithium carbonate (Li₂CO₃).

17. The tape green body of claim 1 further comprising:
a width that is within a range of from 0.5 mm to 600 mm;
a length that is greater than or equal to 300 cm; and
a thickness within a range of from 10 μm to 250 μm

18. The tape green body of claim 1, wherein
the tape green body exhibits a lack of ignition during a continuous process of transforming the tape green body into a ceramic tape at a conveyance rate of greater than or equal to 70 mm/min.

19. A method of manufacturing a ceramic tape comprising:
providing a a tape green body comprising: (i) grains of inorganic sinterable material, (ii) an inorganic hydroxide, and (iii) a binder; and
a continuous binder burnout step comprising feeding the tape green body through a burnout heating zone having a burnout temperature sufficient to burn out at least a portion of the binder from the tape green body.

20. The method of claim 19, wherein
the burnout temperature is within a range of from 150° C. to 600° C.

21. The method of claim 19, wherein:
(i) the tape green body is fed through the burnout heating zone at a conveyance rate that is greater than or equal to 70 mm/min without the tape green body igniting; or
(ii) the tape green body is fed through the burnout heating zone at a conveyance rate that is greater than or equal to 100 mm/min without the tape green body igniting.

22. The method of claim 19, further comprising:
a continuous feed step, occurring before continuous binder burnout step, comprising feeding the tape green body from a source of the tape green body to the burnout heating zone.

23. The method of claim 19, wherein
the source of the tape green body is a spool of the tape green body, and
feeding the tape green body comprises unwinding the tape green body from the spool.

24. The method of claim 19 further comprising:
a composition determination step, occurring before the continuous binder burnout step, comprising selecting the inorganic hydroxide and the binder of the tape green body as a function of the decomposition temperature range of the inorganic hydroxide and the temperature at which the tape green body exhibits with the binder but in the absence of the inorganic hydroxide,
wherein, the temperature at which the tape green body exhibits peak heat release with the binder but in the absence of the inorganic hydroxide falls within the decomposition temperature range of the inorganic hydroxide.

25. The method of claim 19 further comprising:
a continuous sintering step, occurring after the continuous binder burnout step forms a debound tape from the tape green body, comprising feeding the debound tape through a sintering heating zone having a sintering temperature sufficient to sinter at least partially the debound tape into a ceramic tape.

26. The method of claim 25, wherein
the sintering temperature is within a range of from 500° C. to 1700° C.; and
the debound tape is fed through the sintering heating zone at a conveyance rate that is greater than or equal to 70 mm/minute without debound tape igniting.

27. The method of claim 19 further comprising:
a continuous uptake step, occurring after the continuous sintering step, comprising winding the ceramic tape upon a reel.

28. The method of claim 19, wherein
(I) the inorganic sinterable material is greater than or equal to 75 wt % of the tape green body; and
the inorganic hydroxide is less than or equal 20 wt % of the tape green body; or
(II) the inorganic sinterable material comprise one or more of a ceramic material, a glass-ceramic material, and a metal

29. The method of claim 19, wherein
the ceramic material of the tape green body comprises one or more of an oxide, a carbide, a nitride, a boride, an oxynitride, a titanate, a phosphate, a silicate, a sulfide, a fluoride, a carbonate, a zirconate, and a cobaltite; or alkali-containing ceramic material.

30. The method of claim 19 wherein:
(i) the inorganic hydroxide of the tape green body exhibits an endothermic decomposition; or
(ii) the inorganic hydroxide of the tape green body comprises one or more of magnesium hydroxide (Mg(OH)₂), calcium hydroxide (Ca(OH)₂), barium hydroxide (Ba(OH)₂), strontium hydroxide (Sr(OH)₂)), aluminum hydroxide (Al(OH)₃), iron(III) hydroxide (Fe(OH)₃), bismuth hydroxide (Bi(OH)₃), nickel hydroxide (Ni(OH)₂), cobalt hydroxide (Co(OH)₂), aluminum oxide hydroxide (AlO(OH)), manganese hydroxide (Mn(OH)₂), zinc hydroxide (Zn(OH)₂), lanthanum hydroxide (La(OH)₃), copper(II) hydroxide (Cu(OH)₂), cadmium hydroxide (Cd(OH)₂), lead(II) hydroxide (Pb(OH)₂), chromium(III) hydroxide (Cr(OH)₃), iron(II) hydroxide (Fe(OH)₂), and thallium(I) hydroxide (TlOH); or
(iii) the binder comprises one or more of polyvinyl alcohol (PVA), polyethylene glycol (PEG), hydroxypropyl methylcellulose (HPMC), carboxymethylcellulose (CMC), polyacrylic acid (PAA), polyvinylpyrrolidone (PVP), polymethylmethacrylate (PMMA), polyethylmethacrylate (PEMA), polybutylmethacrylate (PBMA) polyhexylmethacrylate (PHMA), polymethylacrylate (PMA), polyethylacrylate (PEA), polybutylacrylate (PBA) polyhexylacrylate (PHMA), ethyl cellulose, cellulose acetate butyrate (CAB), methyl cellulose, polypropylene carbonate (PPC), polybutylene carbonate (PBC), polypropylene-co-cyclohexene carbonate (PPCC), polyvinyl butyral (PVB), a copolymer containing polystyrene, a co-polymer containing polyisobutylene, and a copolymer containing alkyl (meth)acrylates; or
